(19) United States
(12) Patent Application Publication
(10) Pub. No.: US 2005/0287506 A1
(43) Pub. Date: Dec. 29, 2005

(54) Method and system for electronically generating random answers

(76) Inventors: Stephen O. Bozzone, Lauderhill, FL (US); Bonnie J. Bachman, Davie, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/867,618

(22) Filed: Jun. 15, 2004

(51) Int. Cl. G09B 7/00

(52) U.S. Cl. 434/323

(57) ABSTRACT

The invention concerns a method (300) and system (110) for electronically generating random responses in a portable electronic device (110). The method includes the steps of detecting (316) motion of the portable electronic device, in response to the detecting step, generating (318) the random response and outputting (320) the random response to a user of the portable electronic device. The method can further include the steps of prompting (312) the user to ask a question and following a predetermined time period after prompting the user to ask the question, prompting (314) the user to shake the portable electronic device. The prompted question can be answerable with a yes or no.

### BACKGROUND OF THE INVENTION

1. Field of the Invention

This invention relates in general to methods and systems for multimedia games and more particularly, to mobile units on which multimedia games are capable of being played.

2. Description of the Related Art

In recent years, portable electronic devices, such as cellular telephones and personal digital assistants, have become commonplace. These devices have increased in sophistication and complexity, and there is a current push to implement a wide array of functions in them, as well. As an example, many cellular telephone manufacturers have implemented video games into the mobile units that the manufacturers offer for sale. In addition, several video game titles are available for sale over the Internet. Once bought, these games can be wirelessly downloaded. As such, there is a continuing push to develop and make available for public use gaming applications for use on a mobile unit.

### SUMMARY OF THE INVENTION

The present invention concerns a method for electronically generating random responses in a portable electronic device. The method includes the steps of detecting motion of the portable electronic device, generating the random response in response to the detecting step and outputting the random response to a user of the portable electronic device. In one arrangement, the method can further include the steps of prompting the user to ask a question and following a predetermined time period after prompting the user to ask the question, prompting the user to shake the portable electronic device. As an example, the prompting the user to ask the question step can further include prompting the user to ask a question that is answerable with a yes or no.

In another arrangement, the step of outputting the random response can include broadcasting the random response through a speaker or displaying the random response through a display. Also, the random response can be selected from a table of predetermined phrases. As an example, the predetermined phrase is capable of answering a question that is answerable with a yes or no. In addition, the method can further include the step of downloading into the table the predetermined phrases. The method can also include the step of creating through a user interface of the portable electronic device the downloadable predetermined phrases. As an example, the predetermined phrases can be downloaded from an entity that provides a selection of predetermined phrases.

The present invention also concerns a portable electronic device for electronically generating random responses. The portable electronic device includes a motion detecting mechanism—in which the motion detecting mechanism detects motion of the portable electronic device—and a processor coupled to the motion detecting mechanism. In response to the motion detecting mechanism detecting the motion, the processor is programmed to generate the random response. The portable electronic device also includes a user interface section coupled to the processor. The user interface section outputs the random response to a user of the portable electronic device. The device can also include suitable software and/or circuitry to carry out the processes described above.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 illustrates a portable electronic device in accordance with an embodiment of the inventive arrangements;

FIG. 2 illustrates the portable electronic device in communication with a system in accordance with an embodiment of the inventive arrangements;

FIG. 3 illustrates a method for electronically generating random responses in accordance with an embodiment of the inventive arrangements; and

FIG. 4 illustrates a method for downloading predetermined phrases in accordance with an embodiment of the inventive arrangements.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The terms program, software application, and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

This invention presents a method for electronically generating random responses in a portable electronic device. In one arrangement, the portable electronic device can prompt a user to ask a question that can be answerable with a yes or no. The portable electronic device can then prompt the user to shake the portable electronic device. A motion detecting mechanism in the portable electronic device can detect this shaking, and in response, the portable electronic device can generate a random response that may answer the user's question. This random response can be output to the user through any suitable user interface.

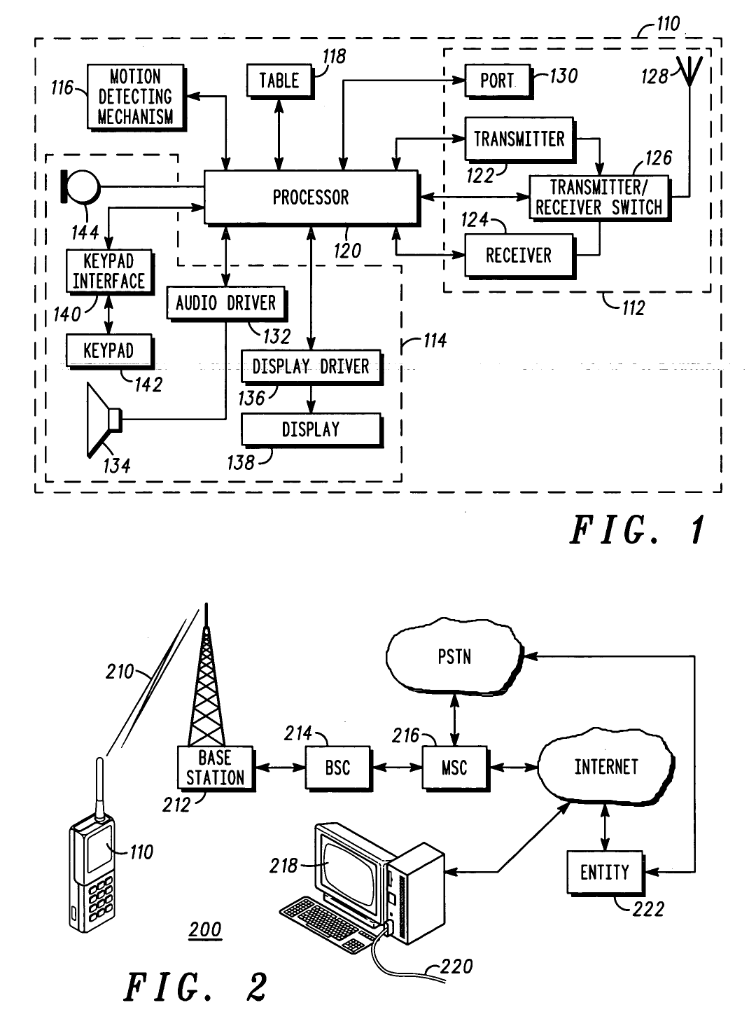

Referring to FIG. 1, a portable electronic device 110 for electronically generating random responses is illustrated. The portable electronic device 110 can be a mobile communications unit—such as a cellular telephone, personal digital assistant, two-way radio, etc.—although the portable electronic device 110 is not limited to these examples. In one arrangement, the portable electronic device 110 can include a receiving section 112, a user interface section 114, a motion detecting mechanism 116, a table 118 and a processor 120. In one arrangement, the receiving section 112 can have a transmitter 122, a receiver 124, a transmitter/receiver (TX/RX) switch 126, an antenna 128 and a port 130, which can receive any suitable connection for transmitting data to the portable electronic device 110. The processor 120 can be coupled to the transmitter 122, the receiver 124, the TX/RX switch 126 and the port 130. The antenna 128 can be coupled to the TX/RX switch 126.

Through the receiving section 112, the portable electronic device 110 can transmit and receive wireless communications signals in a manner well known to those of skill in the art. For example, when receiving signals, the processor 120 can control the TX/RX switch 126, which can permit signals being received by the antenna 128 to pass to the receiver 124. The receiver 124 can convert and demodulate these signals and can transfer them to the processor 120. When the portable electronic device 110 is transmitting signals, the processor 120 can set the TXIRX switch 126 to permit the transmitter 122 to transmit communications signals though the antenna 128. Although discussed primarily in terms of wireless communications, it is understood that the portable electronic device 110 can also be designed to receive signals from a hard-wired connection, such as through the port 130.

In one arrangement, the motion detecting mechanism 116 can detect motion of the portable electronic device 110 and can be coupled to the processor 120. As an example, the motion detecting mechanism 116 can be an accelerometer. Examples of suitable accelerometers include potentiometric accelerometers, linear variable differential transformer (LVDT) accelerometers, variable reluctance accelerometers and piezoelectric accelerometers. Of course, the invention is not limited to these particular examples, as any other suitable accelerometer, or any other instrument suitable for detecting motion, can serve as the motion detecting mechanism 116.

The table 118 can receive and store predetermined phrases and can be coupled to the processor 120. During operation of the invention, the processor 120 can retrieve predetermined phrases from the table 118. As an example, this retrieval can be on a random basis. This process will be explained more below. The processor 120 can also direct predetermined phrases to the table 118 for storage and later retrieval.

The user interface section 114 can include an audio driver 132, a speaker 134, a display driver 136, a display 138, a keypad interface 140, a keypad 142 and a microphone 144. The processor 120 can be coupled to the audio driver 132, the keypad interface 140, the display driver 136 and the microphone 144. Further, the audio driver 132 can be coupled to the speaker 134, the display driver 136 can be coupled to the display 138 and the keypad interface 140 can be coupled to the keypad 142. In one arrangement, the predetermined phrases that the processor 120 selects can be output to the user through the user interface section 114. In addition, the user can create predetermined phrases through the user interface section 114, and these created predetermined phrases can be stored in the table 118.

It must be understood that the portable electronic device 110 of FIG. 1 is merely one example of a portable electronic device that can be used to generate random responses electronically. That is, a portable electronic device can be any device that is capable of detecting motion, generating a random response in response to the detected motion and outputting the random response to a user of the portable electronic device.

Referring to FIG. 2, a system 200 having a portable electronic device 110 and several communications components is shown. As noted earlier, the portable electronic device 110 can be a mobile communications device. As such, the portable electronic device 110 can transmit and receive wireless signals over a wireless communications link 210 to, for example, a base station 212. As is known in the art, the base station 212 can transmit and receive signals from a base site controller (BSC) 214, which can transmit and receive signals from a mobile switching center (MSC) 216. As is also known in the art, the MSC 216 can transmit and receive signals from the Public Switched Telephone Network (PSTN) or the Internet. In this manner, the portable electronic device 110 can transmit and receive voice and data signals to and from a considerable number of sources.

As also alluded to earlier, the portable electronic device 110 can receive signals over a hard-wired connection. As an example, a computer 218 can receive data from the Internet, and the portable electronic device 110 can receive data from the computer 218 through a connection 220 of the computer 218. This connection 220 can be received by the port 130 of the portable electronic device 110. The portable electronic device 110 can also be designed to wirelessly receive data from the computer 218.

In either the wireless or hard-wired connection arrangement, the portable electronic device 110 can receive predetermined phrases from an entity 222. As an example, the entity 222 can be an electronic storefront. The entity 222 can offer for sale predetermined phrases that can be transferred to the portable electronic device 110 through the Internet or even the PSTN. The entity 222 can also offer for free these predetermined phrases to a user of the portable electronic device 110. The operation of the system 200 and how it may be useful in allowing the user to access predetermined phrases will be further described below. It is understood, however, that the invention is not limited to the system 200 shown in FIG. 2. Specifically, the portable electronic device 110 can receive data from any other suitable communications system or component.

Referring to FIG. 3, a method 300 for electronically generating random responses in a portable electronic device is shown. To describe the method 300, reference will be made to FIG. 1. It must be noted, however, that the method 300 can be practiced in any suitable portable electronic device and/or any suitable system. It is also understood that the steps of the inventive method are not limited to the order illustrated in FIG. 3.

At step 310, the method 300 can begin. At step 312, a user can be prompted to ask a question. At step 314, following a predetermined time period after prompting the user to ask the question, the user can be prompted to shake the portable electronic device. For example, referring to FIG. 1, the user can access an application or program that permits the user to practice the inventive method. The user can access the application through a menu, an icon or any other well known method of selection. This selection can be made through the user interface section 114, such as the user inputting information through the keypad 142. The user can also request the application through the display 138 (such as a touch screen display) or the microphone 144, if the portable electronic device 110 can recognize audible commands.

Once the application is accessed, the processor 120 can signal some of the components of the user interface section 114 to cause the user to be prompted. Specifically, the processor 120 can signal the display driver 136, which can cause a message to be displayed on the display 138 that prompts the user to ask one or more questions. In addition, the processor 120 can signal the audio driver 132, which can cause the message to be broadcast over the speaker. The broadcasting audio function and the displaying function can be performed together, or they can be executed independently of one another. In one particular arrangement, the user can be prompted to ask a question that can be answered with a yes or no. It must be stressed, however, that the invention is not so limited, as the user can ask any suitable type of question.

Once it signals the user interface section 114, the processor 120—following a predetermined amount of time—can signal the user interface section 114 once again to cause the user to be prompted to shake the portable electronic device 110. Like the example above, the processor 120 can signal the display driver 136 to cause a message to be displayed on the display 138 that asks the user to shake the portable electronic device 110. The processor 120 can also signal the audio driver 132 to cause the message to be broadcast over the speaker 134.

Referring back to FIG. 3, motion of the portable electronic device 110 can be detected, as shown at step 316. At step 318, in response to the detection of motion, a random response can be generated. This random response can be output to a user of the portable electronic device, as shown at step 320. The method 300 can then end at step 322. An example describing the steps 316-320 will now be presented.

Referring to FIG. 1, once prompted, the user can apply a moving force to the portable electronic device 110. This moving force can be any motion that is sufficient to cause the motion detecting mechanism 116 to detect such motion. After it detects the motion, the motion detecting mechanism 116 can signal the processor 120. In response, the processor 120 can generate a random response. This random response can be in response the question that the user has asked.

To generate the random response, the processor 120 can randomly select a predetermined phrase from the table 118. In one particular arrangement, these predetermined phrases are capable of answering a question that is answerable with a yes or no, although the invention is not limited to such phrases. Suitable examples of predetermined phrases include the following: (1) Yes; (2) No; (3) Ask again later; (4) Reply unclear, try again; (5) Absolutely; and (6) Highly doubtful. Those of skill in the art will appreciate that there are numerous possibilities for these predetermined phrases, and the table 118 can be stored with any suitable number of them.

After the processor 120 randomly selects the predetermined phrase, the processor 120 can signal the user interface section 114 to output the predetermined phrase, i.e., the random response, to a user of the portable electronic device 110. For example, the processor 120 can signal the display driver 136 and/or the audio driver 132 to cause the random response to be displayed on the display 138 or broadcast over the speaker 134, or both. As a result, the portable electronic device 110 can provide a random answer to any suitable questions asked by a user of the portable electronic device 110.

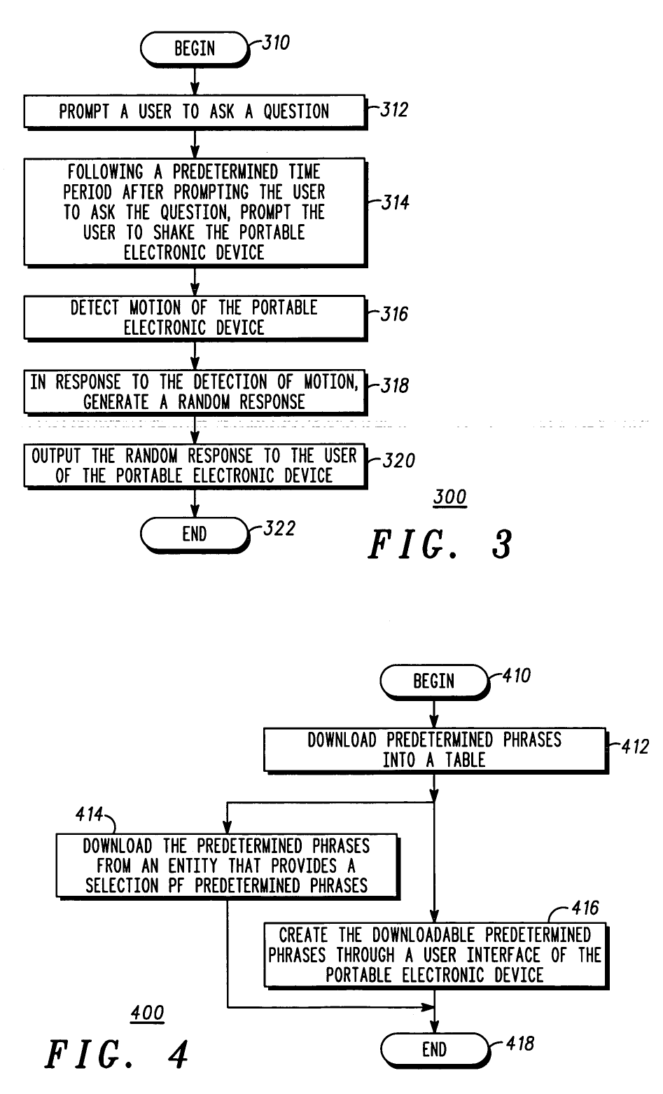

There are several ways to create the predetermined phrases that can be stored in the table 118. For example, during the manufacture of the portable electronic device 110, the manufacturer can program these predetermined phrases into the table 118. In addition, referring to FIG. 4, a method 400 that presents several other ways to add predetermined phrases to the table 118 will be discussed. Reference will be made to FIGS. 1 and 2 in discussing the method 400, although it is understood that the method 400 can be practiced in any other suitable portable electronic device and/or system.

At step 410, the method can begin. At step 412, predetermined phrases can be downloaded into a table. As shown there are two different ways to do such an action. In particular, at step 414, the predetermined phrases can be downloaded from an entity that provides a selection of predetermined phrases. Alternatively, the downloadable predetermined phrases can be created through a user interface of the portable electronic device. At step 418, the method 400 can end.

For example, referring to FIGS. 1 and 2, a user of the portable electronic device 110 can access predetermined phrases offered by the entity 222. As mentioned earlier, the entity 222 can be an electronic storefront, and the entity 222 can have a database that stores predetermined phrases. The entity 222 can offer to a user of the portable electronic device 110 these predetermined phrases for sale or for free. The user can access these predetermined phrases offered by the entity 222 by wirelessly downloading them. That is, the portable electronic device 110 can download the predetermined phrases from the entity 222 through the Internet or PSTN and the MSC 216, the BSC 214, the base station 212 and the wireless communications link 210. The receiving section 112 of the portable electronic device 110 can receive the predetermined phrases, and the processor 120 can downloaded them into the table 118.

In another arrangement, the predetermined phrases can be downloaded from the entity 222 to the computer 218 through the Internet. A user can then download the predetermined phrases from the computer 218 to the portable electronic device 110 by coupling the connector 220 to the port 130 of the receiving section 112. The predetermined phrases can also be wirelessly transferred from the computer 218 to the receiving section 112. After receipt of the phrases, the processor 120 can download the phrases into the table 118. Once the predetermined phrases have been downloaded into the table, the processor 120 may select one or more of them as a random response, in accordance with the method 300 of FIG. 3.

In another example, the user can create predetermined phrases through the user interface section 114. Specifically, the user can create customized predetermined phrases by entering such phrases via the keypad 142. The user may also enter these phrases by using the microphone 144, if the portable electronic device 110 has appropriate voice recognition software. Once entered, the processor 120 can download these phrases into the table 118, where they may eventually serve as a random response. As another example, the user may create such predetermined phrases at the computer 218 or any other suitable device. The user can then transfer the customized phrases to the portable electronic device 110 wirelessly or through a hard- wired connection.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for electronically generating random responses in a portable electronic device, comprising the steps of:
detecting motion of the portable electronic device;
in response to the detecting step, generating the random response; and
outputting the random response to a user of the portable electronic device.

2. The method according to claim 1, further comprising the steps of:
prompting the user to ask a question; and
following a predetermined time period after prompting the user to ask the question, prompting the user to shake the portable electronic device.

3. The method according to claim 2, wherein the prompting the user to ask the question further comprises prompting the user to ask a question that is answerable with at least one of yes and no.

4. The method according to claim 1, wherein the step of outputting the random response comprises at least one of broadcasting the random response through a speaker and displaying the random response through a display.

5. The method according to claim 1, wherein the random response is selected from a table of predetermined phrases.

6. The method according to claim 5, wherein the predetermined phrase is capable of answering a question that is answerable with at least one of a yes and no.

7. The method according to claim 5, further comprising the step of downloading into the table the predetermined phrases.

8. The method according to claim 7, further comprising the steps of creating through a user interface of the portable electronic device the downloadable predetermined phrases.

9. The method according to claim 7, wherein the predetermined phrases are downloaded from an entity that provides a selection of predetermined phrases.

10. A portable electronic device for electronically generating random responses, comprising:
a motion detecting mechanism, wherein the motion detecting mechanism detects motion of the portable electronic device;
a processor coupled to the motion detecting mechanism, wherein in response to the motion detecting mechanism detecting the motion, the processor is programmed to generate the random response; and
a user interface section coupled to the processor, wherein the user interface section outputs the random response to a user of the portable electronic device.

11. The portable electronic device according to claim 10, wherein the processor is further programmed to:
signal the user interface section to prompt the user to ask a question; and
following a predetermined time period after the user is prompted to ask the question, signal the user interface section to prompt the user to shake the portable electronic device.

12. The portable electronic device according to claim 11, wherein the question is answerable with at least one of a yes and no.

13. The portable electronic device according to claim 10, wherein the user interface section further comprises a speaker and a display and wherein the user interface section outputs the random response by at least one of broadcasting the random response through the speaker and displaying the random response through the display.

14. The portable electronic device according to claim 10, further comprising a table of predetermined phrases, wherein the processor is further programmed to select the random response from the predetermined phrases in the table.

15. The portable electronic device according to claim 14, wherein the predetermined phrase is capable of answering a question that is answerable with at least one of a yes and no.

16. The portable electronic device according to claim 14, wherein the processor is further programmed to cause the predetermined phrases to be downloaded into the table.

17. The portable electronic device according to claim 16, wherein the predetermined phrases are created through the user interface.

18. The portable electronic device according to claim 16, wherein the predetermined phrases are downloaded from an entity that provides a selection of predetermined phrases.

19. The portable electronic device according to claim 10, wherein the motion detecting mechanism is an accelerometer.
